(19) United States
(12) Patent Application Publication
(10) Pub. No.: US 2018/0299309 A1
(43) Pub. Date: Oct. 18, 2018

(54) Air Flow Rate Measuring Device

(71) Applicant: Hitachi Automotive Systems, Ltd., Hitachinaka-shi, Ibaraki (JP)

(72) Inventors: Masahiro MATSUMOTO, Tokyo (JP); Hiroshi NAKANO, Tokyo (JP); Yoshimitsu YANAGAWA, Tokyo (JP); Akira KOTABE, Hitachinaka-shi (JP)

(21) Appl. No.: 15/767,526

(22) PCT Filed: Oct. 17, 2016
(86) PCT No.: PCT/JP2016/080639

§ 371 Date: Apr. 11, 2018

(30) Foreign Application Priority Data
Nov. 13, 2015 (JP) 2015-222588

(51) Int. Cl. G01F 1/696; G01F 1/72; G01F 1/66

(52) U.S. Cl. CPC G01F 1/6965; G06F 17/142; G01F 1/662; G01F 1/72

(57) ABSTRACT

In using a fast Fourier transform for correction of a pulsation error in a conventional air flow rate measuring device, the correction is delayed due to the observation time and computation time required for the fast Fourier transform, leading to difficulty in following changes in the pulsation state at high speed. The air flow rate measuring device according to the present invention comprises an air flow rate detector that generates an output signal in accordance with an air flow rate being measured, an amplitude detector that detects a pulsation amplitude from the output signal, a low-pass filter in which the cut-off frequency changes in accordance with the value of the pulsation amplitude, and a waveform arithmetic unit that computes the waveforms of the output signal from the low-pass filter and the output signal. The waveform arithmetic unit is constituted from multipliers, an adder, and a condition determination process. The low-pass filter is constituted from a subtractor, a multiplier, an adder, and a delay element, with the cut-off frequency changing in accordance with the pulsation amplitude by changing the gain of the multiplier with the pulsation amplitude.

### TECHNICAL FIELD

The present invention relates to an air flow measurement apparatus that outputs an air flow signal according to an output signal from an air flow detector, and particularly relates to an air flow measurement apparatus capable of reducing pulsation error caused by a pulsation.

### BACKGROUND ART

As a method for reducing pulsation error in an air flow measurement apparatus, for example, there is a method disclosed in PTL 1. According to PTL 1, an average value is obtained by the average processing unit based on the signal from the air flow detector, a frequency and a pulsation amplitude are obtained by a frequency analysis unit using the fast Fourier transform, a correction amount is calculated from the average value, the frequency, and the pulsation amplitude obtained above, and then, the pulsation error caused by the pulsation of the signal from the air flow detector is corrected.

### CITATION LIST

### Patent Literature

PTL 1: JP-A-2012-112716

### SUMMARY OF INVENTION

### Technical Problem

In the technology disclosed in PTL 1, the high frequency analysis unit uses the fast Fourier transform. In the fast Fourier transform, in order to obtain a desired frequency analysis range and a resolution, it requires a predetermined length of observation time and a sampling frequency, and thus, an amount of calculation also exponentially increases according to the frequency analysis range and the resolution. Therefore, since a predetermined observation time and a predetermined calculation time are required before the result of the fast Fourier transform is output, it takes a long time to calculate the correction amount, and thus, it is not possible to follow the changes in pulsation state. That is, a room for discussion on the changes in the pulsation state remains in the technology disclosed in PTL 1.

The present invention has been made in view of the problems described above, and has an object of providing an air flow measurement apparatus having pulsation error correction processing capable of following the changes in the pulsation state at high speed.

### Solution to Problem

In order to solve the problems described above, the solution can be achieved by performing a waveform calculation on an output signal from the filter in which characteristic changes according to a representative value of the output signal from the air flow detector, and by outputting the air flow signal based on the output on which the waveform calculation is performed.

### Advantageous Effects of Invention

According to the present invention, it is possible to provide an air flow measurement apparatus having pulsation error correction processing capable of following the changes in the pulsation state at high speed.

### BRIEF DESCRIPTION OF DRAWINGS

FIG. 1 is a diagram illustrating a configuration of an air flow measurement apparatus in a first embodiment.

FIG. 2 is a diagram illustrating a configuration of an LPF (low pass filter) 4.

FIG. 3 is a diagram illustrating a disposition of the air flow measurement apparatus 1 to an air inlet pipe.

FIG. 4 are diagrams illustrating operation waveforms from each unit.

FIG. 5 is a diagram illustrating a dependence of a correction amount to a pulsation frequency.

FIG. 6 is a diagram illustrating a configuration of an air flow measurement apparatus in a second embodiment.

FIG. 7 are diagrams illustrating operation waveforms from each unit.

FIG. 8 is a diagram illustrating the dependence of the correction amount on the pulsation frequency.

FIG. 9 is a diagram illustrating a configuration of an air flow measurement apparatus in a third embodiment.

FIG. 10 is a diagram illustrating frequency characteristics of an LPF 40.

FIG. 11 is a diagram illustrating the dependence of the correction amount on the pulsation frequency.

FIG. 12 is a diagram illustrating a configuration of an air flow measurement apparatus in a fourth embodiment.

FIG. 13 is a diagram illustrating a configuration of a pulsation determiner 48.

FIG. 14 are diagrams illustrating output waveforms of a maximum value detector 33 and a minimum value detector 34.

FIG. 15 is a diagram illustrating Vsen−Vmax and Vsen−Vmin in various states.

FIG. 16 is a diagram illustrating a configuration of an air flow measurement apparatus in a fifth embodiment.

FIG. 17 is a diagram illustrating a configuration of an air flow measurement apparatus in a sixth embodiment.

FIG. 18 is a diagram illustrating the dependence of the correction amount on the pulsation frequency.

FIG. 19 is a diagram illustrating a configuration of an air flow measurement apparatus in a seventh embodiment.

FIG. 20 is a diagram illustrating a disposition of the air flow measurement apparatus 1 to the air inlet pipe.

### DESCRIPTION OF EMBODIMENTS

Hereinafter, embodiments of the present invention will be described with reference to the drawings.

### First Embodiment

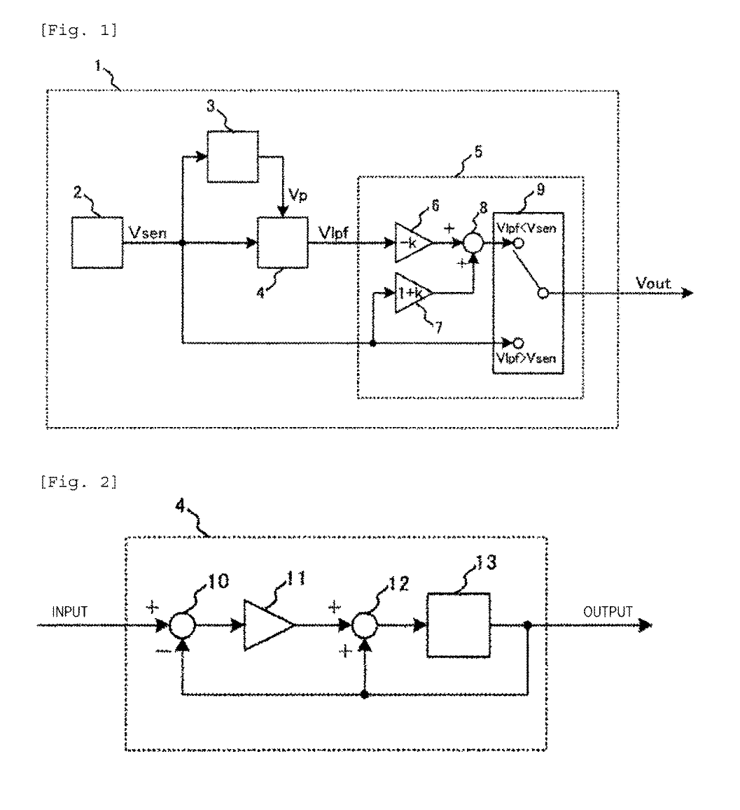

First, an air flow measurement apparatus which is a first embodiment of the present invention will be described using FIG. 1 to FIG. 5.

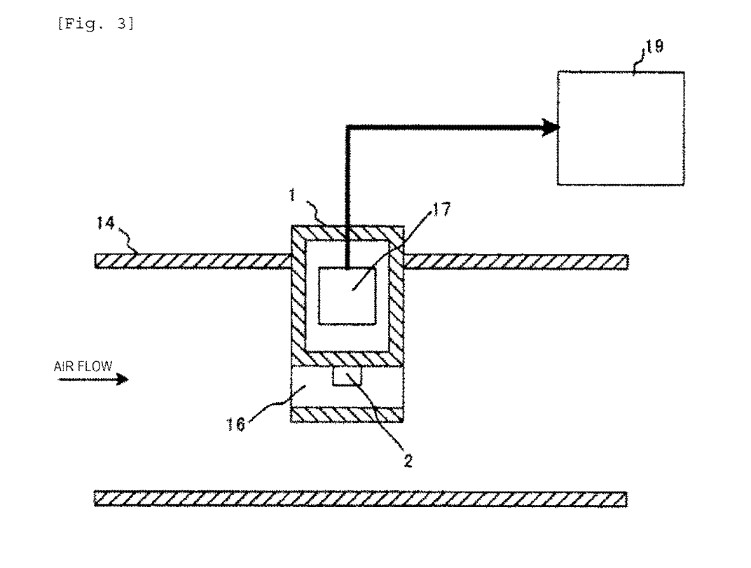

An air flow measurement apparatus 1 in the present embodiment includes an air flow detector 2 that generates an output signal Vsen according to an air flow to be measured, an amplitude detector 3 that detects a pulsation amplitude Vp from the output signal Vsen, a low pass filter (hereafter, LPF) 4 in which a cutoff frequency is changed according to the value of the pulsation amplitude Vp, and a waveform calculator 5 that performs waveform calculation on the output signal Vlpf from the LPF 4 and the output signal Vsen. The waveform calculator 5 includes multipliers 6 and 7, an adder 8, and condition determination processing 9. In addition, as illustrated in FIG. 2, the LPF 4 includes a subtractor 10, a multiplier 11, an adder 12, and a delay element 13. By changing a gain of the multiplier 11 using the pulsation amplitude Vp, the cutoff frequency of the LPF 4 changes according to the pulsation amplitude Vp. The output signal Vsen of the air flow measurement apparatus 1 has a pulsation error caused by the pulsation, and the pulsation error is influenced by the average flow, pulsation amplitude, a pulsation frequency, and the like.

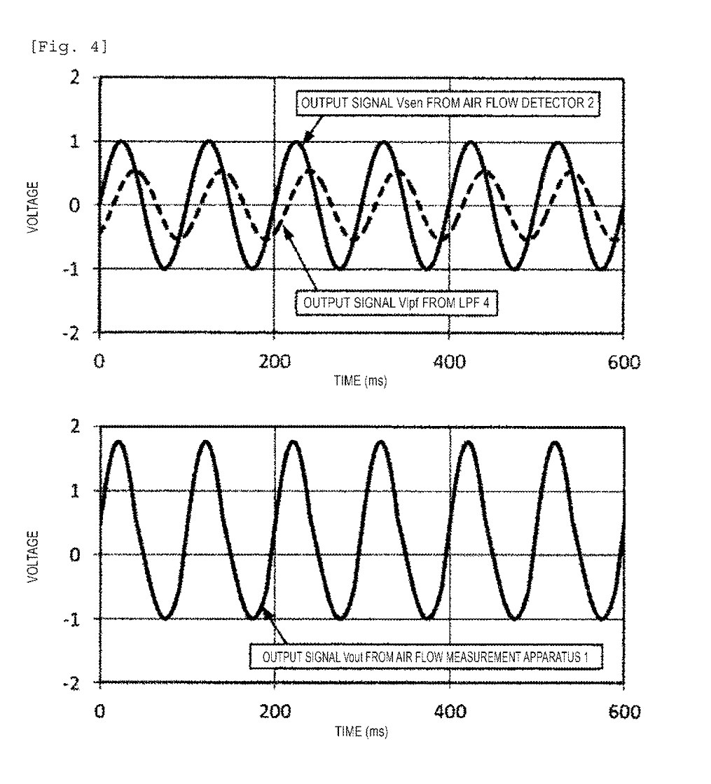

Next, the disposition of the air flow measurement apparatus 1 to the air inlet pipe will be described using FIG. 3. An air flow enters the air inlet pipe 14, and the air flow measurement apparatus 1 is attached to the air inlet pipe 14. The air flow measurement apparatus 1 is configured to include a bypass passage 16, the air flow detector 2 disposed in the bypass passage 16, and a signal processing circuit 17 that processes a signal from the air flow detector 2. In addition, an engine control unit 19 is disposed, which receives a flow signal from the air flow measurement apparatus 1 and performs various controls.

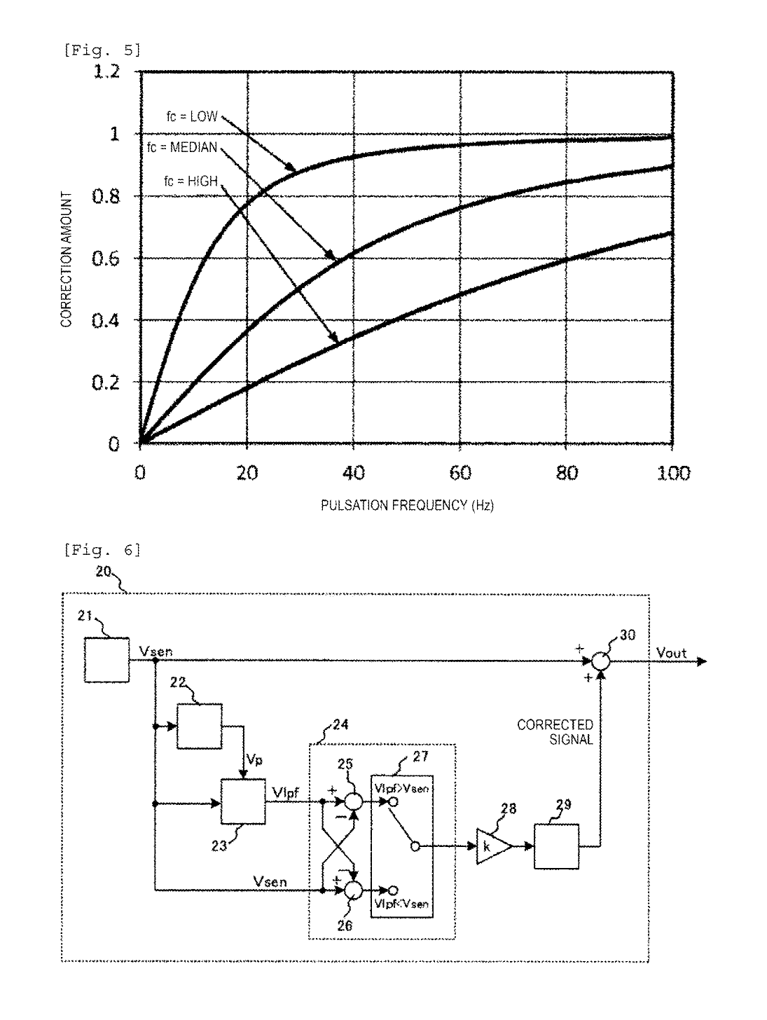

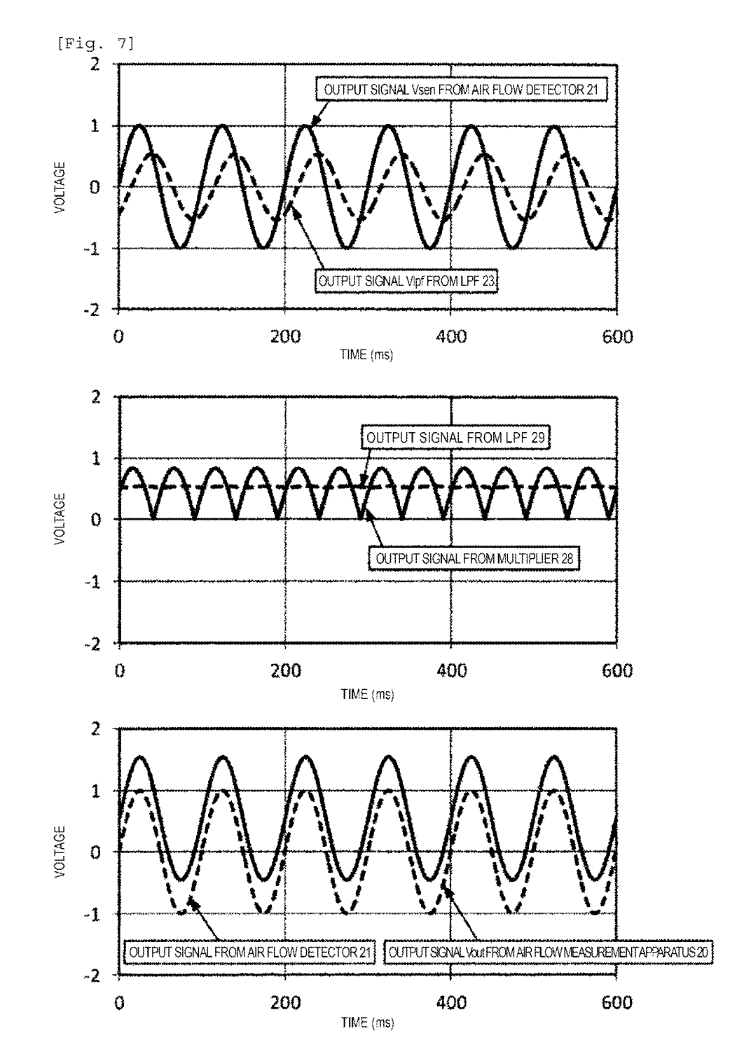

Next, operations of the air flow measurement apparatus 1 will be described using FIG. 4 and FIG. 5. In a case where the output signal Vsen from the air flow detector 2 shows a pulsation waveform as illustrated in FIG. 4, the amplitude of the output signal Vlpf from the LPF 4 decreases according to the frequency of the output signal Vsen and the cutoff frequency of the LPF 4. Here, the waveform calculation is performed on the output signal Vsen and the output signal Vlpf by the waveform calculator 5, and the result makes the output signal Vout of the air flow measurement apparatus 1 as illustrated in FIG. 4 in a case where k=1, and the waveform becomes such that the upper half of the waveform is elongated. As a result thereof, an average value of the output signal Vout changes in a positive direction, and the error due to the pulsation of the air flow detector 2 is corrected by this change in the positive direction, and then, the output of the air flow measurement apparatus 1 is obtained. At this time, as illustrated in FIG. 5, since the correction amount is determined by the pulsation frequency and the cutoff frequency fc of the LPF 4, when the cutoff frequency fc of the LPF 4 increases, the correction amount decreases, and when the cutoff frequency fc of the LPF 4 decreases, the correction amount increases. That is, the pulsation amplitude Vp is detected from the output signal Vsen by the amplitude detector 3, and it is possible to change the correction amount according to the pulsation amplitude Vp and the pulsation frequency by changing the cutoff frequency fc of the LPF 4 according to the pulsation amplitude Vp.

In addition, in the air flow measurement apparatus having the bypass passage 16, when the pulsation amplitude increases (particularly when the pulsation amplitude is equal to or higher than the average value by four times), the flow of the air into the bypass passage 16 decreases with the increase of the pulsation frequency. This occurs because the viscosity of the air inside the bypass passage 16 is greater than the viscosity of the air outside the bypass passage 16. That is, when the pulsation amplitude increases, the flow of the air into the bypass passage 16 decreases with the increase of the pulsation frequency, and a negative error occurs in the output signal Vsen of the air flow detector 2. Therefore, when using the air flow measurement apparatus 1 in the present invention, in a case where the pulsation amplitude Vp is large, it is possible to reduce the pulsation error of the air flow measurement apparatus 1 by increasing the correction amount in the positive direction according to the increase of the pulsation frequency. That is, in a case where the pulsation amplitude Vp is small, the correction amount is decreased by increasing the cutoff frequency fc of the LPF 4, and in a case where the pulsation amplitude Vp is large, the correction amount can is increased by decreasing the cutoff frequency fc of the LPF 4. In addition, since the correction amount increases in the positive direction when the pulsation frequency increases, it is possible to cancel the pulsation error of the air flow detector 2. In this way, it possible to reduce the pulsation error of the air flow measurement apparatus 1.

In addition, in the air flow measurement apparatus 1 in the present invention, since the dependence of the pulsation error on the frequency of the pulsation is corrected using the frequency characteristics of the LPF 4, it is possible to follow the changes in the pulsation state at high speed.

In the related art, since an engine speed is required, it was necessary to dispose a processing circuit that performs the pulsation correction in the engine control unit 19 from which the engine speed can easily be obtained. On the other hand, in the present invention, since the engine speed is not required as in the related art, the pulsation correction can be performed at the air flow measurement apparatus 1 side, and thus, it is possible to transmit a highly accurate signal with the corrected pulsation error to the engine control unit 19.

In addition, since the LPF 4 obtains a vector sum of each frequency for a signal having a plurality of frequencies, the LPF 4 acts to reduce the pulsation error caused by the effects of the higher harmonics wave. Therefore, in the present invention, it is possible to reduce the pulsation error even in a case where the higher harmonics wave is present in the pulsation.

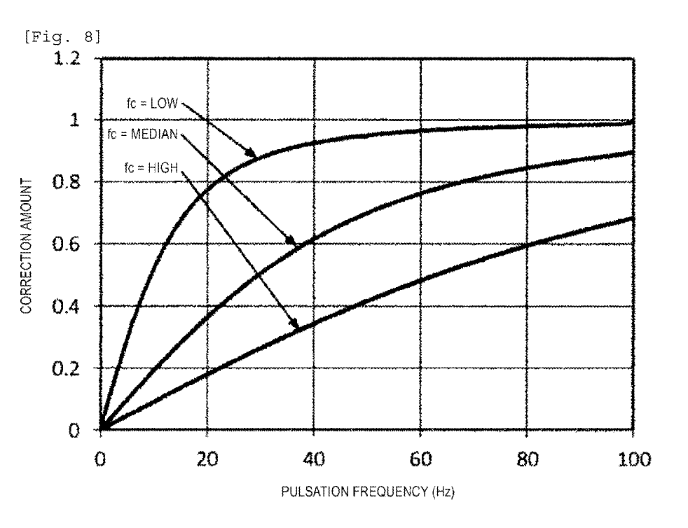

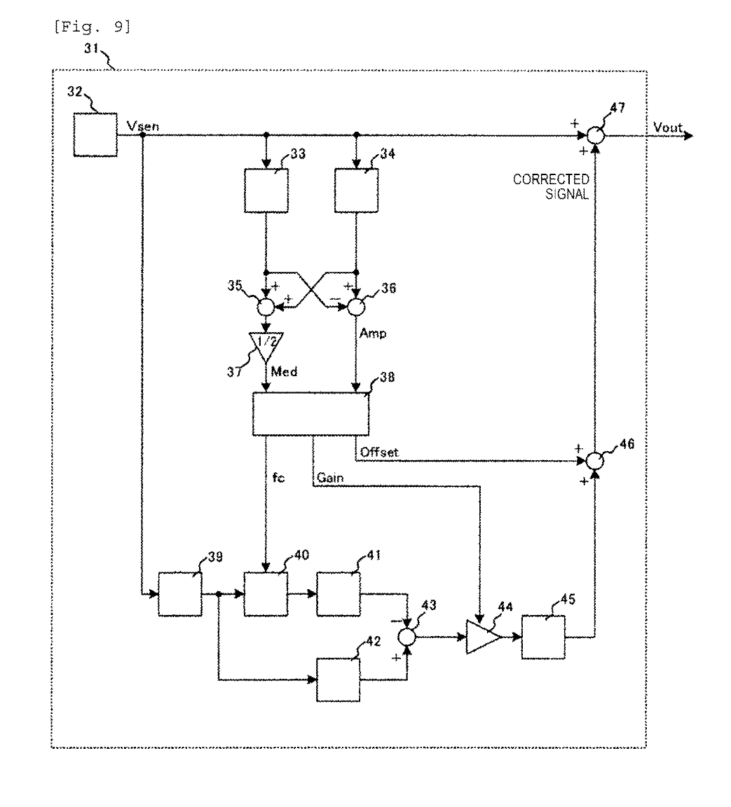

Next, an air flow measurement apparatus which is a second embodiment of the present invention will be described using FIG. 6 to FIG. 8. FIG. 6 is a diagram illustrating a configuration of an air flow measurement apparatus in the second embodiment, FIG. 7 are diagrams illustrating operation waveforms from each unit, and FIG. 8 is a diagram illustrating the dependence of the correction amount on the pulsation frequency.

An air flow measurement apparatus 20 in the present embodiment is configured to include an air flow detector 21 that generates an output signal Vsen according to the air flow to be measured, an amplitude detector 22 that detects a pulsation amplitude Vp from the output signal Vsen, an LPF 23 in which a cutoff frequency changes according to the value of the pulsation amplitude Vp, a waveform calculator 24 that performs waveform calculation on the output signal Vlpf from the LPF 23 and the output signal Vsen, a multiplier 28 that amplifies the output of the waveform calculator 24, an LPF 29 that converts the output of multiplier 28 to DC, and an adder 30 that adds the output of the LPF 29 to the output signal Vsen. The waveform calculator 24 is configured to include subtractors 25 and 26 and condition determination processing 27. The configuration of the LPF 23 is the same as that of the LPF 4 described in the first embodiment, and the cutoff frequency changes according to the pulsation amplitude Vp.

Next, operations of the air flow measurement apparatus 1 will be described using FIG. 7 and FIG. 8. In a case where the output signal Vsen of the air flow detector 21 shows a pulsation waveform as illustrated in FIG. 7, the amplitude of the output signal Vlpf from the LPF 23 decreases according to the frequency of the output signal Vsen and the cutoff frequency of the LPF 23. Here, the waveform calculation is performed on the output signal Vsen and the output signal Vlpf by the waveform calculator 24, in a case where the gain k of the multiplier 18 is 1, the output signal from the multiplier 28 becomes a waveform like a full-wave rectification as illustrated in FIG. 7. The output signal from the multiplier 28 is converted into DC by the LPF 29 to show the waveform illustrated in FIG. 7. The output signal (corrected signal) of the LPF 29 is added to the output signal Vsen of the air flow detector 21 by the adder 30, and then, the output signal Vout of air flow measurement apparatus 20 is obtained.

The air flow measurement apparatus in the second embodiment has a configuration basically the same as that of the air flow measurement apparatus in the first embodiment, and the following improvements are added thereto. In the air flow measurement apparatus in the second embodiment, the waveform like the full-wave rectification is output by the waveform calculator 24, and the DC conversion by the LPF 29 becomes easy. In addition, the LPF 29 is provided to convert the corrected signal into DC. In this way, the signal band of the corrected signal is restricted. In a case of adopting the waveform calculator 5 in the first embodiment, there is no problem while the correction amount is small, but in a case where the gain k is increased and the correction amount is increased, a noise due to the waveform calculation increases. In contrast, in the present embodiment, the corrected signal is converted into DC by the LPF 29, and thus, it is possible to reduce the increase of the noise.

In the present embodiment also, similarly to the first embodiment, as illustrated in FIG. 8, the correction amount is determined by the pulsation frequency and the cutoff frequency fc of the LPF 23, and when the cutoff frequency fc of the LPF 23 increases, the correction amount decreases, and when the cutoff frequency fc of the LPF 23 decreases, the correction amount increases. That is, the pulsation amplitude Vp is detected from the output signal Vsen by the amplitude detector 22, and it is possible to change the correction amount according to the pulsation amplitude Vp and the pulsation frequency by changing the cutoff frequency fc of the LPF 23 according to the pulsation amplitude Vp. In addition, as described above, in the air flow detector having the bypass passage, in a case where the pulsation amplitude is large, a negative error occurs as the pulsation frequency increases. Therefore, when using the air flow measurement apparatus 20 in the present invention, since the correction amount can be increased according to the pulsation frequency, it is possible to reduce the pulsation error caused by the pulsation of the air flow measurement apparatus 1.

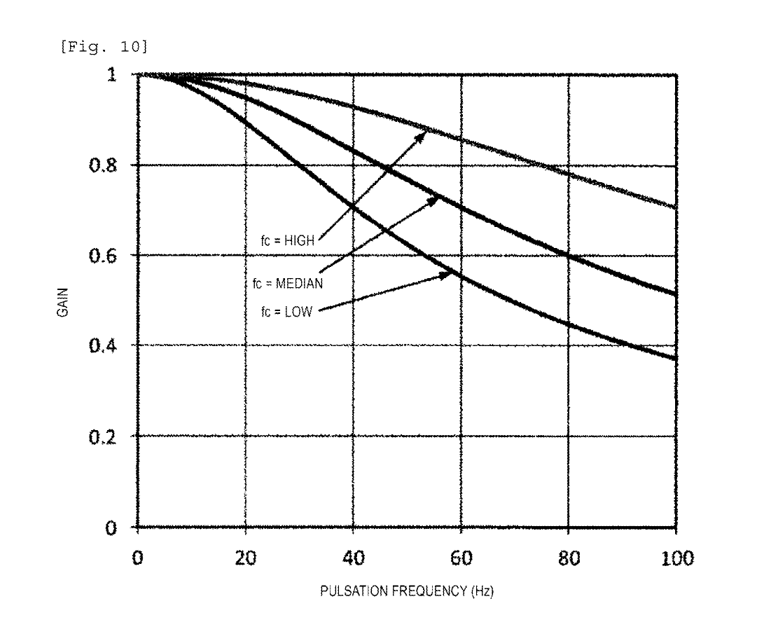

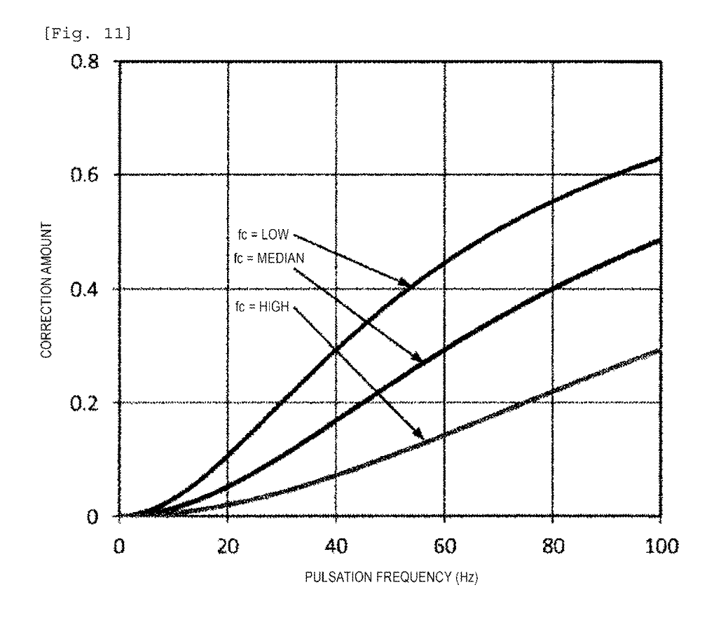

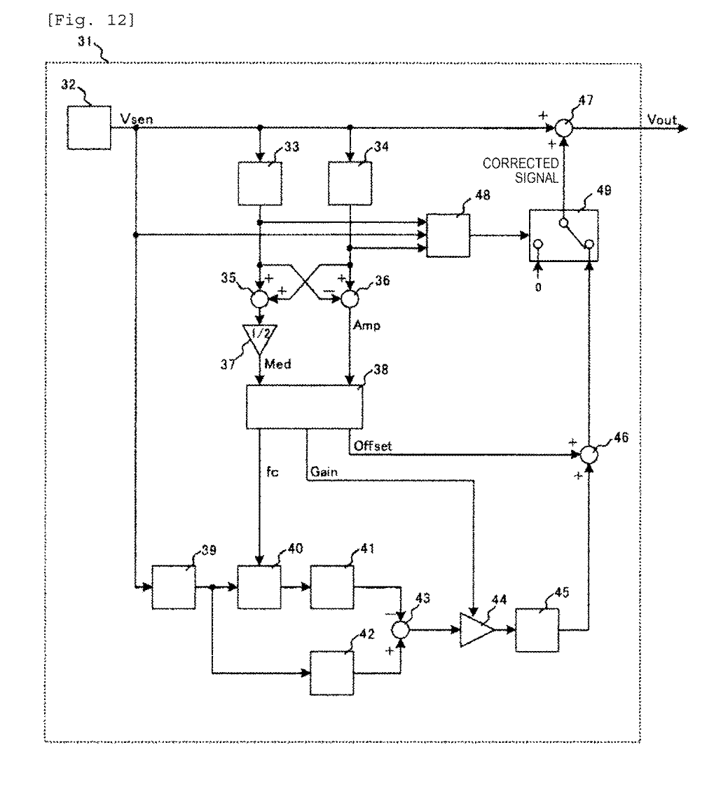

Next, an air flow measurement apparatus which is a third embodiment of the present invention will be described using FIG. 9 to FIG. 11. FIG. 9 is a diagram illustrating a configuration of an air flow measurement apparatus in the third embodiment, FIG. 10 is a diagram illustrating frequency characteristics of an LPF 40, and FIG. 11 is a diagram illustrating the dependence of the correction amount on the pulsation frequency.

An air flow measurement apparatus 31 in the present embodiment is configured to include an air flow detector 32 that generates an output signal Vsen according to the air flow to be measured, a maximum value detection circuit 33 that detects a maximum value from the output signal Vsen, a minimum value detection circuit 34 that detects a minimum value from the output signal Vsen, an adder 35 that obtains a sum of the outputs of the maximum value detection circuit 33 and the minimum value detection circuit 34, a multiplier 37 that obtains a median value Med by multiplying the output of the adder 35 by ½, a subtractor 36 that obtains an amplitude Amp by calculating the difference between the outputs of the maximum value detection circuit 33 and the minimum value detection circuit 34, a two-dimensional map 38 that outputs a cutoff frequency fc, an amplification factor Gain, and an offset value Offset using the median value Med and the amplitude Amp as input, an HPF (high pass filter) 39 that removes the DC component of the output signal Vsen, an LPF 40 in which the cutoff frequency changes according to the cutoff frequency fc output from the two-dimensional map 38, a rectifier 41 that performs a full-wave rectification on the output of the LPF 40, a rectifier 42 that performs a full-wave rectification on the output of the HPF 39, a subtractor 43 that obtains a difference between the outputs of the rectifier 41 and the rectifier 42, a multiplier 44 that amplifies the output of the subtractor 43 by changing the amplification factor according to the amplification factor Gain output from the two-dimensional map 38, an LPF 45 that converts the output of the multiplier 44 into DC, an adder 46 that adds the offset value Offset output from the two-dimensional map 38 to the output of the LPF 45, and an adder 47 that obtains the output signal Vout by adding the output of the adder 46 to the output signal Vsen. The configuration of the LPF 40 is the same as that of the LPF 4 described in the first embodiment, and the cutoff frequency can be changed according to the cutoff frequency fc output from the two-dimensional map 38.

The air flow measurement apparatus in the third embodiment has a configuration basically the same as that of the air flow measurement apparatus in the second embodiment, and the following improvements are added thereto. In the air flow measurement apparatus in the third embodiment, the maximum value detection circuit 33 and the minimum value detection circuit 34 are provided, and by calculating the outputs therefrom, the median value Med and the amplitude Amp are obtained. The two-dimensional map 38 to which the median value Med and the amplitude Amp are input is provided to output the cutoff frequency fc, the amplification factor gain, and offset value Offset. In this way, it is possible to adjust the cutoff frequency of LPF 40 using not only the amplitude information of the output signal Vsen in the second embodiment but also two kinds of information such as the median value Med and the amplitude Amp. In addition, using the two-dimensional map 38, it is possible to control the correction amount more freely. Since the input to the two-dimensional map 38 may be any value as long as the value represents the feature of the output signal Vsen, any of the average value, the median value, the amplitude, the maximum value, the minimum value, the sum of the maximum value and minimum value, or the difference between maximum value and minimum value of the output signal Vsen, maybe used. In addition, in the present embodiment, not only the cutoff frequency of LPF 40 but also the amplification factor Gain and the offset value Offset can be manipulated, and thus, the correction amount can be controlled more freely. In this way, it possible to further reduce the pulsation error of the air flow measurement apparatus 1.

In addition, the errors due to the pulsation hardly occur at the low frequency, and the errors tend to increase from a specific frequency. In order to cope with this, in the configuration in the present embodiment, the full-wave rectification is performed on the outputs of the LPF 40 and the HPF 39 respectively, and the difference therebetween is output. As illustrated in FIG. 10, the frequency characteristic of the LPF 40 shows such that the gain becomes 1 at the low frequency and the gain decreases from 1 when the frequency exceeds a predetermined frequency. Therefore, by obtaining the difference between the signal of the rectifier 41 which is the result of the full-wave rectification performed on the output signal from the LPF 40 and the signal of the rectifier 42 which is the result of the full-wave rectification performed on the output of HPF 39 using the subtractor 43, the output characteristics of the subtractor 43 shows as the frequency characteristics illustrated in FIG. 11, and thus, the correction amount is 0 at the low frequency and the correction amount increases when the frequency exceeds a predetermined frequency. In this way, since the frequency characteristics closer to the frequency characteristics of the pulsation error can be realized, it is possible to further reduce the pulsation error of the air flow measurement apparatus 31.

In addition, similarly to the second embodiment, even in a case where the higher harmonics wave is present, the pulsation error can be further reduced.

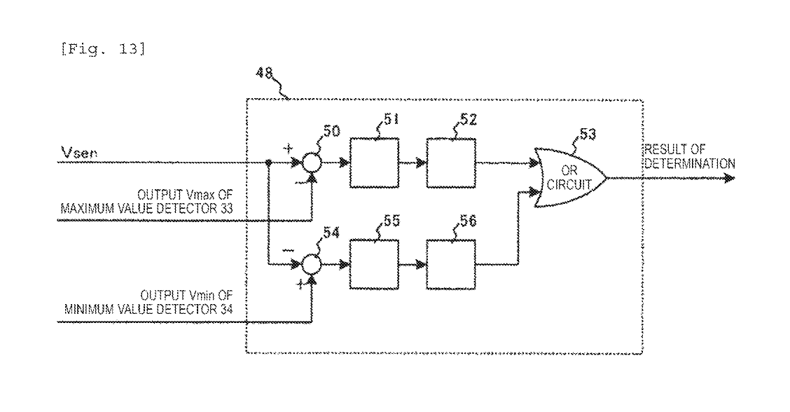

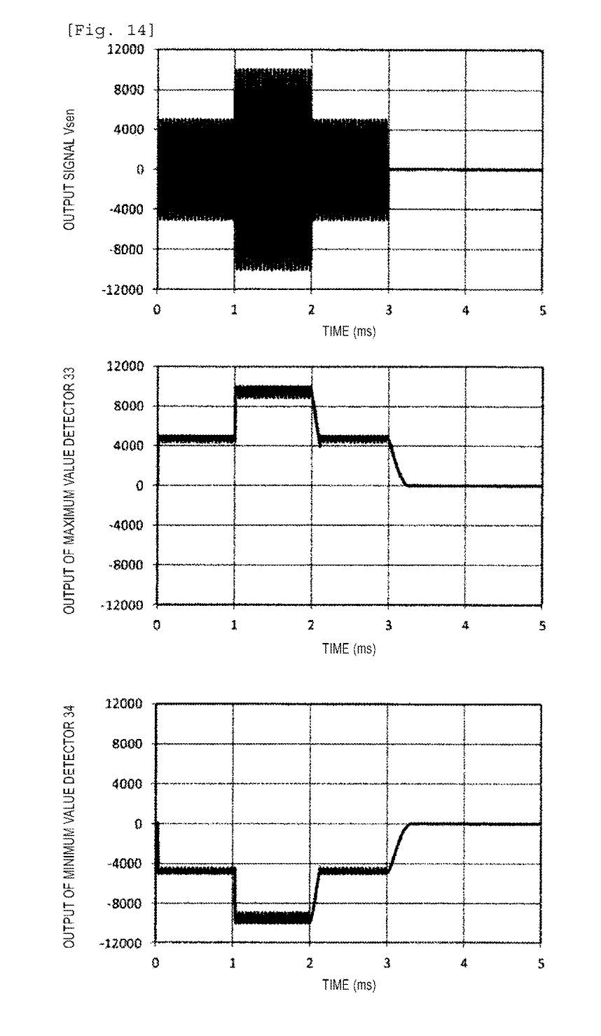

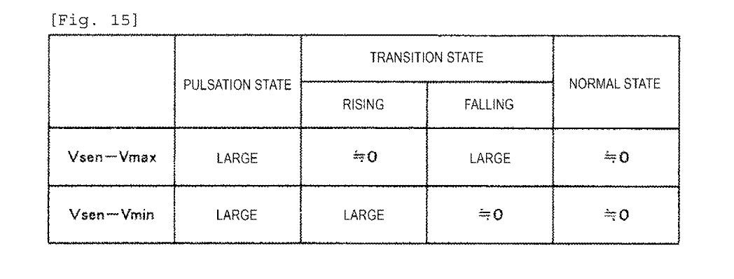

Next, an air flow measurement apparatus which is a fourth embodiment of the present invention will be described using FIG. 12 to FIG. 15. FIG. 12 is a diagram illustrating a configuration of an air flow measurement apparatus in the fourth embodiment, FIG. 13 is a diagram illustrating a configuration a pulsation determiner 48, FIG. 14 are diagrams illustrating the output waveforms of a maximum value detector 33 and a minimum value detector 34, and FIG. 15 is a diagram illustrating Vsen−Vmax and Vsen−Venin in various states.

The air flow measurement apparatus in the fourth embodiment has a configuration basically the same as the sensor apparatus in the third embodiment, and the following improvements are added thereto. In the present embodiment, a pulsation determiner 48 is added, and the switch 49 sets the corrected signal to 0 when the state is not the pulsation state.

As illustrated in FIG. 13, the pulsation determiner 48 is configured to include a subtractor 50 that obtains a difference between the output signal Vsen and the output Vmax of the maximum value detector 33, a hold circuit 51 that holds the output of the subtractor 50 for a fixed time, a comparator 52 that determines whether the output of the hold circuit 51 is larger than a predetermined value or smaller, a subtractor 54 that obtains a difference between the output signal Vsen and the output Vmin of the minimum value detector 34, a hold circuit 55 that holds the output of the subtractor 54 for a fixed time, a comparator 56 that determines whether the output of the hold circuit 55 is larger than a predetermined value or smaller, and an OR circuit 53 that obtains a logical sum of the comparator 52 and the comparator 56.

In a case where the pulsation amplitude of the output signal Vsen changes, the outputs of the maximum value detector 33 and the minimum value detector 34 change as illustrated in FIG. 14. Here, maximum value detector 33 rises quickly and falls slowly. On the other hand, the minimum value detector 34 falls quickly and rises slowly. According to this operation, the maximum value detector 33 and the minimum value detector 34 cause the operation delay with respect to the change of the amplitude of the output signal Vsen. As a result hereof, there is a possibility of outputting an unnecessary signal in the transient state of the air flow. In order to prevent this, in the present embodiment, the pulsation determiner 48 is added, and the switch 49 sets the corrected signal to 0 when the state is not the pulsation state.

FIG. 15 illustrates Vsen−Vmax and Vsen−Vmin in various states. In the pulsation state, both Vsen−Vmax and Vsen−Vmin are large. On the other hand, in a transient state, only one of Vsen−Vmax or Vsen−Vmin becomes large. In addition, in a normal state, both Vsen−Vmax and Vsen−Vmin approaches almost zero. Utilizing the above-described fact, the pulsation determiner 48 determines whether or not the state is the pulsation state. That is, when both Vsen−Vmax and Vsen−Vmin are large, it is determined to be the pulsation state, and at other cases, it is determined not to be the pulsation state. When the state is not the pulsation state, by setting the corrected signal to 0, it is possible to eliminate unnecessary correction which may be caused by the operation delay of the maximum value detector 33 and the minimum value detector 34.

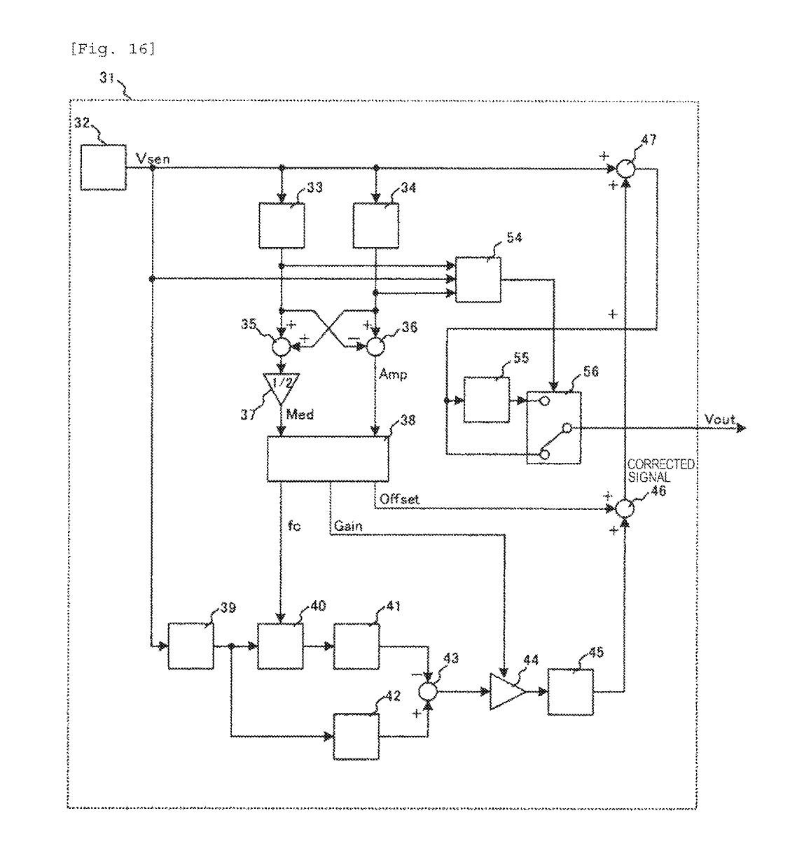

Next, an air flow measurement apparatus which is a fifth embodiment of the present invention will be described using FIG. 16. FIG. 16 is a diagram illustrating a configuration of an air flow measurement apparatus in the fifth embodiment. The air flow measurement apparatus in the fifth embodiment has a configuration basically the same as the sensor apparatus in the third embodiment, and the following improvements are added thereto. In the present embodiment, a normal state determiner 54 is added, and when the state is the normal state, the switch 56 adds LPF 55 to the signal path of the output signal Vout. The structure of the normal state determiner 54 is basically the same as that of the pulsation determiner 48 described above, and in the normal state, it is determined that the state is the normal state using the fact that both Vsen−Vmax and Vsen−Vmin become almost zero as illustrated in FIG. 15.

In the present embodiment, the normal state determiner 54 determines that the state is the normal state, and in a case of the normal state, by adding the LPF 55 to the signal path of the output signal Vout, the noise of the output signal Vout in the normal state can be reduced. In addition, in a transient state, since the normal state determiner 54 does not operates, the LPF 55 is not added to the signal path of the output signal Vout. Therefore, the noise of the output signal Vout in the normal state can be reduced without impairing the responsiveness in the transient state.

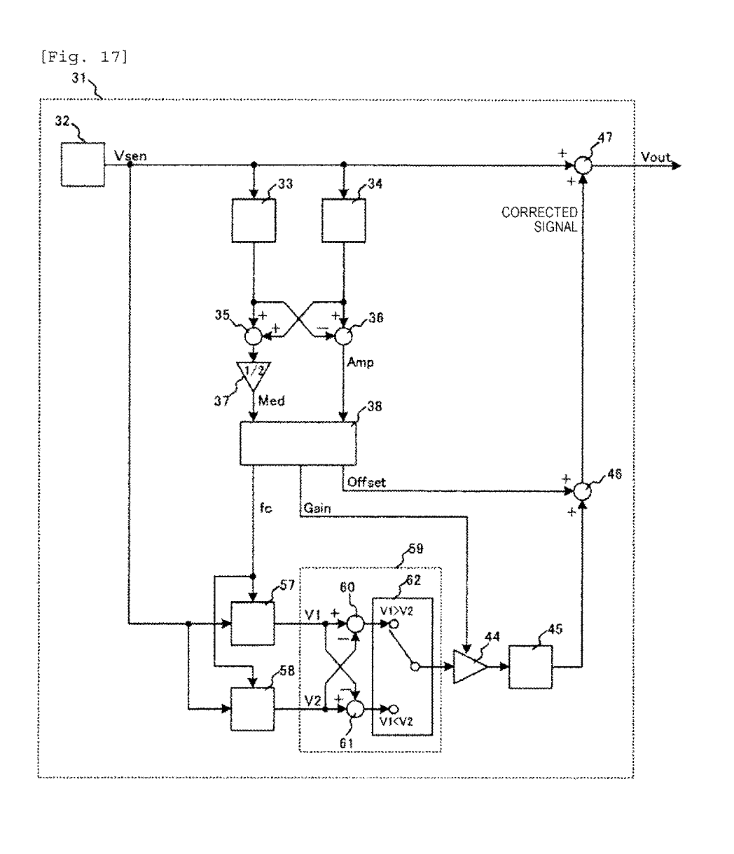

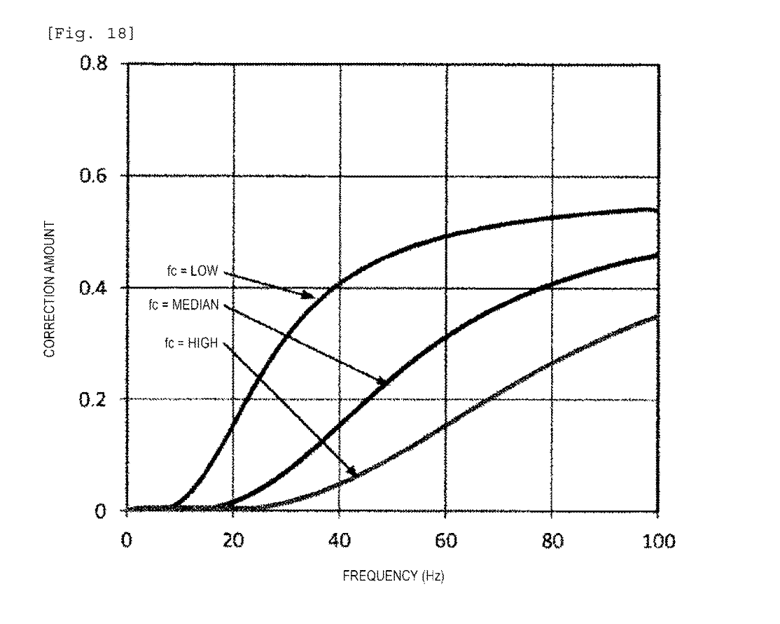

Next, an air flow measurement apparatus which is a sixth embodiment of the present invention will be described using FIGS. 17 and 18. FIG. 17 is a diagram illustrating a configuration of an air flow measurement apparatus in the sixth embodiment, and FIG. 18 is a diagram illustrating the dependence of the correction amount on the pulsation frequency. The air flow measurement apparatus in the sixth embodiment has a configuration basically the same as the sensor apparatus in the third embodiment, and the following improvements are added thereto.

In the present embodiment, a secondary LPF 57 and a primary all-pass filter 58 are disposed, and a waveform calculator 59 performs waveform calculation on the outputs of the secondary LPF 57 and the primary all-pass filter 58. The waveform calculator 59 is configured to include subtractors 60 and 61 and condition determination processing 62.

In a case of changing the cutoff frequency of the secondary LPF 57 and the time constant of the primary all-pass filter 58 at a fixed ratio, the output waveform of the secondary LPF 57 and the output waveform of the primary all-pass filter 58 becomes the same at the low frequency. Therefore, as illustrated in FIG. 18, the correction amount at the low frequency is 0 and it is possible to obtain characteristics in which the correction amount sharply increases when the frequency exceeds a predetermined frequency. In addition, In addition, the pulsation errors hardly occur at the low frequency, and the errors tend to increase from a specific frequency. By using the air flow measurement apparatus in the present embodiment, since the frequency characteristics closer to the frequency characteristics of the pulsation error can be realized, it is possible to further reduce the pulsation error of the air flow measurement apparatus 31.

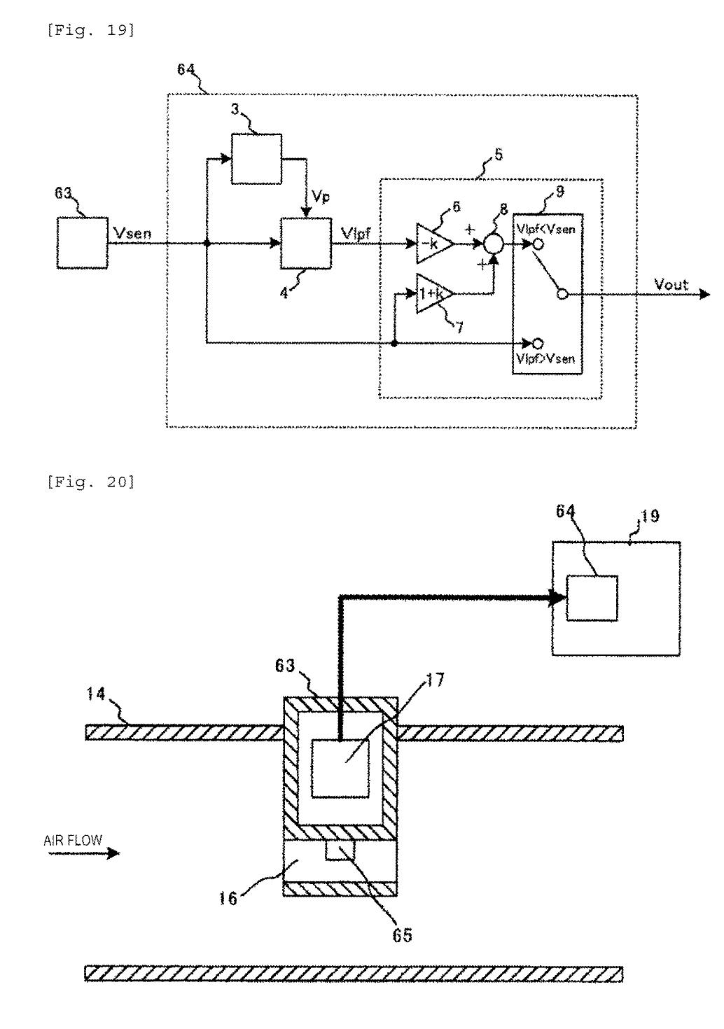

Modification examples of each embodiment of the present invention will be described using FIG. 19 and FIG. 20.

As illustrated in FIG. 19 and FIG. 20, a pulsation correction processing circuit 64 described in detail in each embodiment above is disposed in the engine control unit 19. The output signal Vsen detected by the air flow detector 65 of the air flow measurement apparatus 63 may be input to the engine control unit 19 and the pulsation correction may be performed by the engine control unit 19 side.

### REFERENCE SIGNS LIST

1 air flow measurement apparatus
2 air flow detector
3 amplitude detector
4 LPF (low pass filter)
5 waveform calculator
6 multiplier
7 multiplier
8 adder
9 condition determination processing
10 subtractor
11 multiplier
12 adder
13 delay element
14 air inlet pipe
15 air flow sensor
16 bypass passage
17 signal processing circuit
18 flow detection element
19 engine control unit
20 air flow measurement apparatus
21 air flow detector
22 amplitude detector
23 LPF
24 waveform calculator
25 subtractor
26 subtractor
27 condition determination processing
28 multiplier
29 LPF
30 adder
31 air flow measurement apparatus
32 air flow detector
33 maximum value detection circuit
34 minimum value detection circuit
35 adder
36 subtractor
37 multiplier
38 two-dimensional map
39 HPF (high pass filter)
40 LPF
41 rectifier
42 rectifier
43 subtractor
44 multiplier
45 LPF
46 adder
47 adder
48 pulsation determiner
49 switch
50 subtractor
51 hold circuit
52 comparator
53 OR circuit
54 subtractor
55 hold circuit
56 comparator
57 secondary LPF
58 primary all-pass filter
59 waveform calculator
60 subtractor
61 subtractor
62 condition determination processing

1. An air flow measurement apparatus comprising:
an air flow detector; and
a filter of which characteristics are changed based on an output signal from the air flow detector,
wherein the air flow measurement apparatus outputs an air flow signal based on an output of the air flow detector and an output via the filter.

2. The air flow measurement apparatus according to claim 1, further comprising:
a waveform calculation unit that performs waveform calculation on the output via the filter; and
an adding unit that adds an output via the waveform calculation unit to the output of the air flow detector.

3. The air flow measurement apparatus according to claim 2,
wherein the number of filters is plural, and
wherein signals from the plurality of filters are input to the waveform calculation means, and
wherein the waveform calculation means performs the waveform calculation on the plurality of input signals.

4. The air flow measurement apparatus according to claim 1,
wherein the characteristics of the filter are changed according to any one of an average value, a median value, an amplitude, a maximum value, a minimum value, a sum of the maximum value and the minimum value, and a difference between the maximum value and the minimum value of the output signal from the air flow detector.

5. The air flow measurement apparatus according to claim 4 further comprising:
representative value detection means for detecting any one of the average value, the median value, the amplitude, the maximum value, the minimum value, the sum of the maximum value and the minimum value, and the difference between the maximum value and the minimum value of the output signal from the air flow detector; and
a map that outputs an amount of adjustment for adjusting the characteristics of the filters according to a result of detection by the representative value detection means.

6. The air flow measurement apparatus according to claim 1,
wherein the filter changes a cutoff frequency according to a pulsation amplitude of the output signal from the air flow detector.

7. The air flow measurement apparatus according to claim 1 further comprising:
a maximum value detector that detects a maximum value of an output signal from the air flow detector, and
a minimum value detector that detects a minimum value of an output signal from the air flow detector,
wherein the output signal from the output device is set to be the same as the output signal from the air flow detector in a case where the difference between the output signal from the air flow detector and the output signal from the maximum value detector is greater than a predetermined value and in a case where the difference between the output signal from the air flow detector and the output signal from the minimum value detector is greater than a predetermined value.

8. An air flow measurement apparatus comprising:
a maximum value detector that detects a maximum value of an output signal from the air flow detector; and
a minimum value detector that detects a minimum value of an output signal from the air flow detector,
wherein low pass filter processing is performed on the output signal from the output device in a case where the difference between the output signal from the air flow detector and the output signal from the maximum value detector is smaller than a predetermined value and in a case where the difference between the output signal from the air flow detector and the output signal from the minimum value detector is smaller than a predetermined value.

9. The air flow measurement apparatus according to claim 2,
wherein the filter obtains a vector sum of correction amounts of each frequency with respect to a signal of a plurality of frequencies of the output signal from the air flow detector.
